(19) United States
(12) Patent Application Publication
(10) Pub. No.: US 2019/0156737 A1
(43) Pub. Date: May 23, 2019

(54) Display Degradation Compensation

(71) Applicant: Microsoft Technology Licensing, LLC, Redmond, WA (US)

(72) Inventors: Minhyuk Choi, Mill Creek, WA (US); Rajesh Dighde, Redmond, WA (US); Matthew Morris, Seattle, WA (US); Ying Zheng, Redmond, WA (US)

(21) Appl. No.: 15/821,612

(22) Filed: Nov. 22, 2017

(51) Int. Cl. G09G 3/3225; G09G 3/20; G09G 5/10

(52) U.S. Cl. CPC G09G 3/3225; G09G 3/2003; G09G 2320/048; G09G 2320/0673; G09G 2320/045; G09G 5/10

(57) ABSTRACT

A display driver circuit includes a first memory in which a plurality of gamma adjustment datasets are stored, each gamma adjustment dataset of the plurality of gamma adjustment datasets corresponding with a respective amount of display degradation, a second memory in which selection instructions and compensation instructions are stored, and a processor configured via execution of the selection instructions to select one of the plurality of gamma adjustment datasets based on usage data indicative of past display operation. The processor is further configured via execution of the compensation instructions to generate drive control signaling in accordance with the selected gamma adjustment dataset to compensate for display degradation arising from the past display operation.

### BACKGROUND OF THE DISCLOSURE

Organic light emitting diode (OLED) displays often degrade over time. For instance, the luminance of an OLED display often decreases with aging and usage of the OLED structures in each pixel of the display. The luminance decreases as the efficiency of the organic materials in the OLED structures degrades.

OLED displays are configured to compensate for the efficiency degradation. In one compensation technique, each pixel of the display is configured with additional circuitry for use as the efficiency degrades. In another compensation technique, a gamma control voltage is generated to implement gray-scale adjustments to reach a desired luminance level.

### DESCRIPTION OF THE DRAWING FIGURES

For a more complete understanding of the disclosure, reference is made to the following detailed description and accompanying drawing figures, in which like reference numerals may be used to identify like elements in the figures.

FIG. 1 is a block diagram of a device having a display with a display driver circuit configured to compensate for display degradation in accordance with one example.

FIG. 2 is a flow diagram of a method of display degradation compensation in accordance with one example.

FIG. 3 is a flow diagram of a gamma adjustment profile selection procedure of the method of FIG. 2 in accordance with one example.

The embodiments of the disclosed displays, devices, circuits, and methods may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION

Display driver circuits and methods that compensate for display degradation are described. The compensation may be useful in connection with displays, such as organic light emitting diode (OLED) displays, that exhibit efficiency degradation over time. The degradation compensation may also be useful in connection with non-uniformities present initially, insofar as the compensation may take into account measurement data for a population of devices.

The degradation may be compensated by selection of a gamma adjustment profile or other dataset corresponding with a level or amount of display degradation. The compensation may thus follow a model of display degradation. The amount of display degradation may be predicted or otherwise determined via measurement data, such as usage time, brightness level, and/or other usage parameters tracked or otherwise collected over time. Other usage parameters may be calculated as a function of the measured data. Given the usage parameters, one of a number of gamma adjustment profiles is then selected by a selection switch. The selected gamma adjust profile is then used to provide gamma voltage control signals to a compensator that, in turn, controls a data driver.

The disclosed circuits and methods may provide an empirical solution. For instance, measurements of a population of displays may be used to develop a degradation model. The degradation model may characterize an amount of degradation (e.g., 5%, 10%, etc.) relative to a number of usage parameters, as well as provide a gamma adjustment profile to address the respective amount of degradation. The profile may map luminance values to gamma voltages for compensation of the respective amount of degradation. Measurement and/or calculation of the usage parameter(s) may then be used to first select the appropriate gamma adjustment profile and, for a given luminance level, determine the gamma voltage.

In some cases, the respective gamma adjustment profile for each degradation amount is stored on a separate memory unit. For example, a one-time programmable (OTP) memory unit may be used as the memory unit. Switching between different gamma adjustment profiles may then be achieved by selecting a different OTP memory unit. The switching is done over time as the display efficiency decreases, i.e., the degradation progresses. The OTP memory units may be integrated with a display driver integrated circuit (DDIC) or other display driver circuitry. Any non-volatile memory (either integrated with, or separate from, the DDIC) may be used to stored the gamma adjustment profile data. Alternatively or additionally, the degradation history and gamma adjustment profile data is stored in a remote storage device, such as a server (e.g., cloud storage device). Remote storage may allow data from different displays to be compared or otherwise used. For example, two displays that are used together (e.g., as tiles or otherwise side-by-side) may degrade at different rates, in which case different gamma profiles may be used to dynamically adjust the two displays (e.g., on a continual basis) based on the use/degradation history. Remote storage may also be useful in multiple display scenarios when one of the displays fails and is replaced. The information stored remotely may then be used to facilitate a good match of (and/or via) the gamma profiles. In OLED examples, different gamma adjustment profiles may be applied for the different color sub-pixels of the display (e.g., red, green, and blue).

The degradation compensation may be applied across the entire display (e.g., over an entire display panel) or on a zone-by-zone or other sectional or localized basis. In the former case, the respective gamma voltage correction for each sub-pixel color may be applied across the entire display (e.g., all zones of the display). In the latter case, different zones or other sections of the display may have different gamma adjustment profiles applied thereto. In either case, the degradation compensation of the disclosed circuits and methods may be combined with other localized compensation methods, thereby decreasing or minimizing display discrepancies and non-uniformities.

The display degradation compensation of the disclosed circuits and methods avoids the limitations presented by other compensation techniques. The degradation compensation may adapt over time to address with different usage characteristics. The fixed circuits used to implement internal compensation techniques may not present such adaptability. The selection of a gamma adjustment profile of the disclosed techniques is capable of providing degradation compensation without requiring an unwieldy amount of data storage, as in external compensation techniques. The degradation compensation techniques may also avoid relying on additional circuitry or other devices, such as sensor(s) for external compensation or additional transistors for internal compensation.

Notwithstanding the foregoing differences, the compensation techniques of the disclosed circuits, displays, devices, and methods may be implemented in combination with other compensation methods. For example, the disclosed circuits and methods may also implement an internal compensation method. Alternatively or additionally, an external compensation method is implemented.

Although described in connection with OLED displays, the disclosed circuits and methods are not limited to use with a particular type of display. The disclosed circuits and methods are useful with a wide variety of displays and devices. For instance, the disclosed circuits and methods are well suited for use in large format displays, such as monitors and televisions, despite the memory-related and other advantages provided for handheld, mobile, and other small devices.

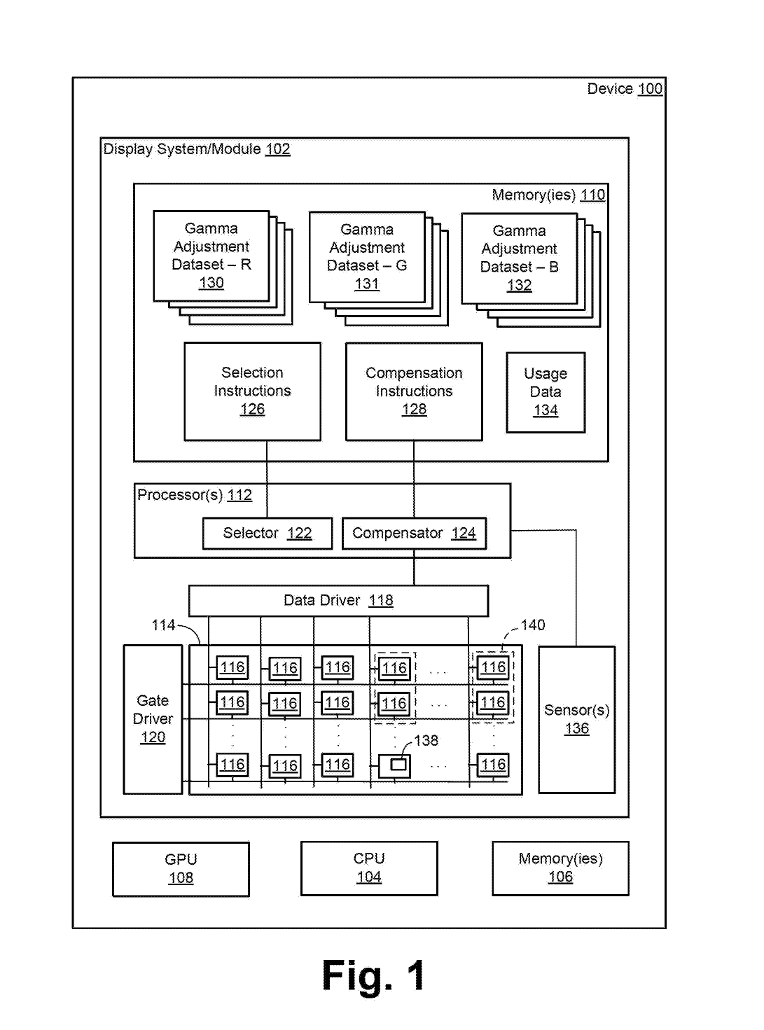

FIG. 1 depicts an electronic device 100 having a display system (or module) 102 configured for display degradation compensation. The display system 102 may be integrated with other components of the electronic device 100 to a varying extent. The display system 102 may be or include a graphics subsystem of the electronic device 100. Any number of display systems may be included. In this example, the device 100 also includes a processor 104, one or more memories 106, and a graphics processing unit (GPU) 108. In some cases, the display system 102 generates a user interface for an operating environment (e.g., an application environment) supported by the processor 104 and the memories 106. The processor 104 may be a general-purpose processor, such as a central processing unit (CPU), or any other processor or processing unit. The GPU 108 may be dedicated to graphics- or display-related functionality. Any number of such general and specific processors or processing units may be included.

The display system 102 may be communicatively coupled to the processor 104 and/or the GPU 108 to support the display of video or other images via the user interface. In the example of FIG. 1, the processor 104 and/or the GPU 108 provides frame data indicative of each image frame of the images to the display system 102. The frame data may be generated by the processor 104, the GPU 108, and/or another component of the device 100. The frame data may be alternatively or additionally obtained by the processor 104 and/or the GPU 108 from the memory 106 and/or another component of the device 100. The GPU 108 may be considered a component of the display system 102.

The display system 102 includes one or more memories 110, one or more processors 112, and a display panel 114. The display panel 114 includes an array of pixels 116. The pixels 116 may be formed in a stack of films or other layers of the display panel 114. For example, the display panel 114 may be an active matrix OLED (AMOLED) or other OLED display, in which case a number of organic layers are disposed between anode and cathode layers driven by a thin film transistor (TFT) backplane. Voltages applied to the anode and cathode layers cause the stack of the organic layers to emit light. In some cases, the light emitted by the OLED structure is red, green, or blue. Each pixel 116 may thus include sub-pixels dedicated to the specific colors, i.e., red, green, and blue. In other cases, white light is emitted. Other types of active or passive display panels may be used.

The pixels 116 are driven by one or more display driver circuits or drive circuitry. In the example of FIG. 1, the pixels 116 are driven by a data driver 118 and a gate driver 120. The data driver 118 and the gate driver 120 are coupled to the array of pixels 116 via respective sets of electrical connections as schematically shown. Data lines are provided to carry the drive signaling from the data driver 118. Address lines are provided to carry the gate control signaling from the gate driver 120. The data driver 118 and the gate driver 120 may include respective circuitry configured to generate voltage signals to drive and control the transistors of the backplane, respectively. The data driver 118, the gate driver 120 may be integrated with one another on a display driver integrated circuit (DDIC). Various types of control and addressing arrangements may be used.

The processor(s) 112 are configured to control the data driver 118 and the gate driver 120. The processor(s) 112 may be responsive to instructions stored in the memory(ies) 110 and/or hardcoded to implement the processing via, for instance, circuitry or other hardware. The example of FIG. 1 provides instances of both types of processors for ease in illustration and description. Any combination of the instances of the processors 112 may be used. The processor(s) 112 may be integrated with the data driver 118 and/or the gate driver 120 to any desired extent. For example, one or more of the processor(s) 112 may be provided on the DDIC.

The processor(s) 112 and the memory(ies) 110 are configured to compensate for display degradation. The processor(s) 112 may provide the degradation compensation by modifying the operation of the data driver 118. The drive signaling is thus adjusted to compensate for the degradation. To that end, the processor(s) 112 may be coupled to the data driver 118 as shown to provide control signaling to the data driver 118. In some cases, the control signaling is or includes a gamma voltage signal or other gamma-related control signal (e.g., a gamma voltage reference voltage). For instance, the gamma voltage signal may be indicative of a gamma correction factor directed to addressing the non-linearity of human vision. The display degradation compensation may be provided by adjusting the gamma voltage signal or other gamma-related control signal. For instance, as the efficiency of the pixels 116 decreases over time, the gamma voltage signal may be adjusted to compensate for the decrease in luminance that would otherwise result from the decrease in efficiency.

In the example of FIG. 1, the processor(s) 112 include, or are configured to implement, a selector (or switch) 122 and a compensator 124 to implement the display degradation compensation. In some cases, the selector 122 and the compensator 124 are configured via execution of selection instructions 126 and compensation instructions 128, respectively, stored in the memory(ies) 110. Alternatively or additionally, the selector 122 and/or the compensator 124 include circuitry and/or other hardware. The selector 122 and/or the compensator 124 may be components of a DDIC or otherwise integrated with the data driver 118 or other component of the display system 102.

The degradation compensation is provided via selection of a gamma adjustment profile (or other dataset) appropriate for a certain amount of display degradation. Instead of relying on only a single gamma adjustment profile, a plurality of gamma adjustment profiles (or other datasets) 130-132 are stored in the memory(ies) 110. Each profile of the plurality of gamma adjustment profiles 130-132 models or otherwise corresponds with a respective amount of degradation of the array of pixels 116. In some cases, each gamma adjustment profile 130-132 is or includes a gamma-luminance profile. The gamma-luminance profile maps gamma voltage against luminance. For instance, the gamma-luminance profile specifies a gamma voltage for a given luminance level. In the example of FIG. 1, separate pluralities of gamma-luminance profiles are provided for each sub-pixel color. The gamma adjustment profiles 130 are for red sub-pixels. The gamma adjustment profiles 131 are for green sub-pixels. The gamma adjustment profiles 132 are for blue sub-pixels. The separate profiles may be useful to address different amounts of degradation exhibited by the respective sub-pixels.

The selector 122 or other processor 112 is configured to select one of the plurality of gamma-luminance profiles 130-132 based on usage data 134 indicative of past operation of the array of pixels 116. To that end, the selector 122 or other processor 112 may be configured via execution of the selection instructions 126. In some cases, the selector 122 is configured as, or includes, a switch. The switch may be responsive to the usage data 134 and/or a control signal generated in response to the usage data.

The usage data 134 may include stress and other usage history data. In some cases, the usage data is or includes data indicative of a time period length of the past display operation. For instance, the usage data may specify the number of hours that the display system 102 has been in operation. Alternatively or additionally, the usage data is or includes indicative of brightness levels of the past display operation. Various types of other usage data may be collected, provided, and used. In some cases, the usage data 134 may be indicative of operation under certain conditions, such as operation at elevated temperatures.

The usage data 134 may be collected in various ways. In the example of FIG. 1, the usage data 134 may be obtained via one or more sensors 136. The sensor(s) 136 may be in optical, electrical or other communication with the display panel 114, the pixels 116, and/or other components of the display system 102. Optical sensing may be used to track the brightness levels of the past operation. Electrical sensing may be used to detect voltage and/or current levels indicative of the past operation.

Alternatively or additionally, the usage data 134 is obtained via operation of the processor 104, the GPU 108, or other component of the device 100. For instance, the processor 104 may track the hours of operation. Still other components may be used to obtain the usage data 134. In one example, the device 100 includes a temperature sensor to track the operating temperature of the display system 102 and/or the device 100.

In some cases, the selector 122 or other processor 112 is configured to calculate a usage parameter for the display system 102. The calculation may be based on the usage data 134 detected or collected for the past display operation. The usage parameter may then be used alone or in combination with the usage data 134 to support the selection. For instance, the selector 122 or other processor 112 may then be configured via execution of the selection instructions 126 to select one of the plurality of gamma adjustment datasets 130-132 in accordance with the usage parameter.

The usage data may be sub-pixel color-specific. Each gamma adjustment dataset of the plurality of gamma adjustment datasets is directed to gamma adjustment for a respective sub-pixel color. For instance, the selector 122 may receive usage data relative to red pixel usage to select one of the gamma adjustment profiles 130 for the red sub-pixels. Similarly for the green sub-pixel colors, the selector 122 may receive green sub-pixel usage data to select one of the gamma adjustment profiles 131 for the green sub-pixels. For the blue sub-pixel colors, the selector 122 may receive blue sub-pixel usage data to select one of the gamma adjustment profiles 132 for the blue sub-pixels.

The selector 122 may implement a threshold-based procedure to select one of the gamma adjustment profiles 130-132. For instance, the usage data for a respective parameter (e.g., usage time, brightness level, or other stress history parameter) is compared with a set of thresholds. Further such threshold comparisons for other parameters may also be implemented. Each threshold corresponds with an amount of display degradation (e.g., 5%, 10%, 15%, etc.). The results of the threshold comparisons may be averaged or otherwise compiled to estimate the amount of display degradation. The selector 122 may then select the gamma adjustment profile 130-132 that corresponds with the estimated amount of display degradation. Additional and/or alternative selection procedures may be used.

The compensator 124 is configured to generate control signaling for the data driver 118 in accordance with the selected gamma-luminance profile 130-132. To that end, the compensator 124 and/or other processor 112 may be configured via execution of the compensation instructions 128. The control signaling is directed to compensating for the display degradation arising from the past display operation. In some cases, the control signaling includes one or more signals indicative of voltage correction data derived from the selected gamma-luminance profile 130-132. For example, the voltage correction data may be generated as a function of a desired luminance (or brightness level). The selected profile maps the desired luminance level to a respective voltage correction value. In the example of FIG. 1, the compensator 124 provides the control signaling to the data driver 118. The data driver 118 may use the voltage correction data to adjust the drive voltages for the array of pixels 116.

The compensator 124 may provide alternative or additional output data via the control signaling. For instance, the compensator 124 may use the selected gamma-luminance profile 130-132 to determine the adjusted drive voltages. For instance, the compensator 124 may generate data and/or other signals indicative of the adjusted drive voltages as a function of the selected profile and the desired luminance levels. In some cases, the output of the compensator 124 is or includes an adjusted digital pixel value based on the gamma profile.

The control signaling may include multiple control signals. For instance, the control signaling generated by the compensator 124 may be specific to sub-pixel color. In OLED and other cases, respective profiles are selected for each sub-pixel color (e.g., red, green, and blue). The compensator 124 may thus generate respective control signals for each selected profile.

The data driver 118 is responsive to the control signaling to compensate for degradation of the array of pixels 116 arising from the past operation. The drive voltages provided on the data lines thus reflect the adjustments arising from the compensation.

The compensation processing may differ from the example of FIG. 1. For instance, the selector 122 and the compensator 124 may be integrated with one another in other cases. For example, the compensator 124 includes the selector 122 or the switch thereof. Alternatively or additionally, the compensator 124 may be integrated with the data driver 118 to any desired extent.

The gamma adjustment profiles or other datasets 130-132 may be stored in the memory(ies) 110 in various arrangements and architectures. The memory(ies) 110 may include a first memory 110 and a second memory 110. The plurality of gamma adjustment datasets 130-132 are stored in the first memory 110. The selection and compensation instructions 126 and 128 are stored in the second memory 110. The first memory 110 may include one or more programmable storage units. In some cases, each programmable storage unit has a respective gamma adjustment dataset (or a respective set of datasets) stored therein.

The first and second memories 110 may be integrated with one another in a single data storage unit. The data storage unit may be or include any type of firmware or programmable read-only memory. Alternatively, the first and second memories 110 are provided via respective data storage units.

One or more of the processors 112 may determine a gamma adjustment profile or dataset from the selected gamma adjustment datasets 130-132. For example, the selector 122 may be configured via execution of the selection instructions to determine a gamma adjustment profile after selecting one of the gamma adjustment datasets 130-132. In some cases, the determination may be an interpolation, extrapolation, or other calculation based on the selected gamma adjustment dataset 130-132. The drive control signaling may then be generated in accordance with the calculated or otherwise determined gamma adjustment profile. The determination may thereby allow the compensation to be tuned to a more detailed level of degradation.

The compensation based on the gamma adjustment datasets 130-132 may be combined with other compensation schemes. Various internal and/or external compensation techniques may be implemented by one or more of the processors 112. These techniques may be configured to compensate for display degradation and/or other display non-uniformities. The techniques may be implemented on a pixel-by-pixel basis, unlike the compensation techniques based on the gamma adjustment datasets 130-132.

One or more of the sensors 128 may be used to collect data to support the other compensation schemes. The output of the sensor(s) 128 may be provided as feedback to the processor(s) 112. For example, the sensor(s) 128 may be or include an optical sensor configured to detect a brightness level or measure some other optical characteristic of the array of pixels 116. Other types of sensors may be used. For example, the sensor(s) may be or include an electrical sensor configured to detect a voltage level, current level, or other electrical characteristic of the display system 102.

The display panel 114 and the processor(s) 112 may be configured to support or implement internal compensation. For instance, each pixel 116 of the array of pixels 116 may include respective internal compensation circuitry 138. The circuitry 138 may be or include one or more additional transistors and/or other circuitry to compensate for the display degradation. For example, the additional transistors may be configured with a different threshold, or turn-on, voltage. The compensator 124 and/or other processor 112 may be configured (e.g., via the compensation instructions 130) to implement the internal compensation by providing control signals or other control signaling for the data driver 118 that selects a respective transistor or otherwise controls the internal compensation circuitry 138. Use of a transistor with a lower threshold may compensate for a reduction in OLED or other display efficiency by increasing the output luminance for a given drive voltage. Alternative or additional internal compensation techniques may be used.

The compensator 124 may be alternatively or additionally configured to implement external compensation via feedback from the array of pixels 116. The sensor(s) 128 may be used to collect and provide the feedback data. The external compensation may be based on data stored in the memory(ies) 110, such as data correlating an electrical characteristic or other display parameter with a gamma correction factor or other adjustment factor. For example, the sensor(s) 128 may measure the OLED driving voltage and feed the measured voltage to the compensator 124. The compensator 124 may correlate the measured voltage with an amount of OLED degradation, and then adjust the control signaling accordingly. For instance, the compensator 124 may then adjust the control signaling for the data driver 118 according to the gamma correction factor. Additional or alternative display parameters may be used, including, for instance, the OLED pixel driving current, the luminance level, etc.

The compensation techniques based on the gamma adjustment datasets 130-132 may be applied across the entire display panel 114 or on a sectional basis to portions of the display panel 114. The display panel 114 and, thus, the array of pixels 116, may be divided up into multiple zones 140 (or sections). Each display zone 140 may be considered to include a respective pixel array. Each such pixel array corresponds with a subset of the array of pixels 116. The above-described compensation processing may then be implemented on a zone-by-zone basis. The selector (or selector switch) 122 and the compensator 124 are configured to operate for a respective zone 140 separate from other zones 140 of the display panel 114. For instance, one or more of the processors 112 may be configured to iteratively implement the selection instructions 126 and the compensation instructions 128 to compensate for the display degradation separately for each display zone 140. Alternatively, a single, selected gamma-luminance profile is applied across all of the zones 140 of the display panel 114.

Some of the components of the display system 102 may be integrated. For example, one or more of the memories 110, one or more of the processors 112, and/or one or more of the drivers may be integrated to any desired extent. In some cases, the components are integrated in firmware. Alternatively or additionally, the components are integrated as a system-on-a-chip (SoC) or application-specific integrated circuit (ASIC).

The display system 102 may include additional, fewer, or alternative components. For example, the display system 102 may not include a dedicated processor, and instead rely on the CPU or other processor 104. The display system 102 may not include the memory (or memories) 110, and instead use the memories 106 to support display-related processing. In some cases, instructions implemented by, and data generated or used by, the processor 112 of the display system 102 may be stored in some combination of the memories 106 and the memories 110.

The selection instructions 126, the compensation instructions 128, and the gamma adjustment datasets 130-132 may be arranged in discrete software modules or instruction sets in the memories 110. Alternatively, two or more of the instructions or datasets 126, 128, 130-132 may be integrated to any desired extent. The instructions or definitions 126, 128, 130-132 may alternatively or additionally be integrated with other instructions, definitions, or specifications stored in the memories 110. Additional instructions, modules, or instruction sets may be included. For instance, one or more instruction sets may be included for processing touch inputs in cases in which the display system 102 includes a touchscreen or other touch-sensitive surface.

The usage data 134 is stored in the memory(ies) 110. Other storage locations and/or arrangements may be used, such as the memory(ies) 106. Alternatively or additionally, the usage data 134 is processed without storage in the memory(ies) 110.

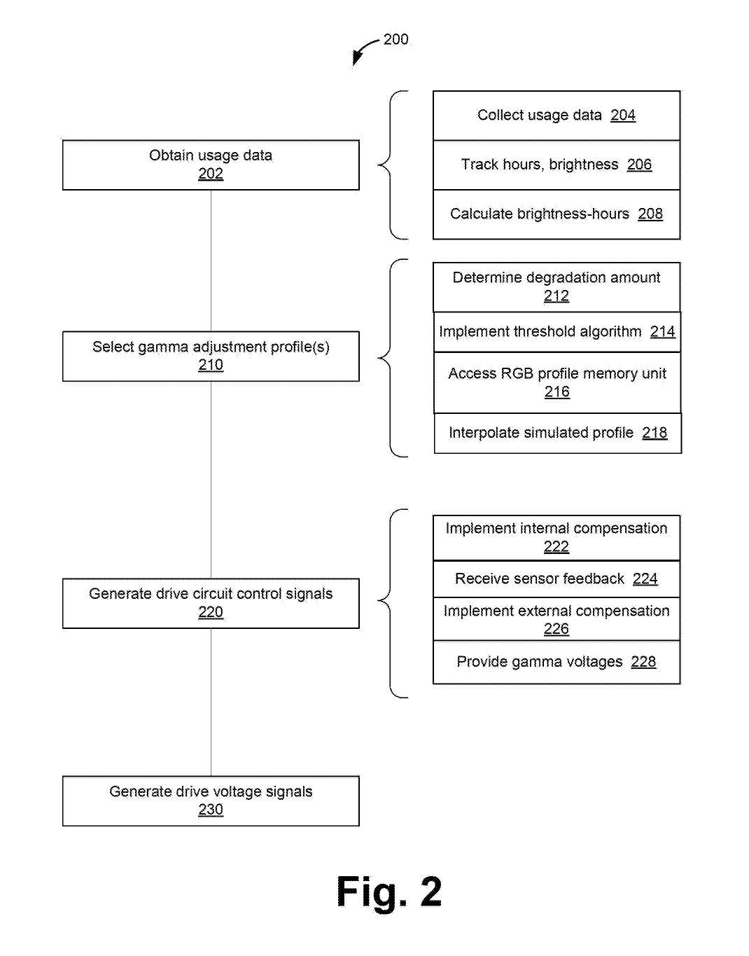

FIG. 2 depicts an exemplary method 200 of controlling a display to compensate for display degradation. The method 200 is computer-implemented. For example, one or more processors of the electronic device 100 shown in FIG. 1 and/or another electronic device may be configured to implement the method or a portion thereof. The implementation of each act may be directed by respective computer-readable instructions executed by the processor 104 (FIG. 1), the GPU 108, and/or one or more of the processor(s) 112, and/or another processor or processing system. Additional, fewer, or alternative acts may be included in the method 200. For example, the method 200 may include a number of acts directed to monitoring the output or other characteristics of the display operation. The method may also include acts that direct or otherwise apply a control signal to a backlight unit.

The method 200 may begin with one or more acts related to initiating the control and operation of a display or display panel thereof. The display panel includes an array of pixels as described above. For example, one or more processors and/or driver circuits of a display module may be activated. The method 200 may be implemented concurrently with such activation and/or after a period of time has elapsed. In some cases, the method 200 may be implemented after the display has been operated for a predetermined amount of time.

In an act 202, usage data indicative of past operation of the display (or array of pixels) is obtained. The usage data may be collected on a display-wide or zone-by-zone basis. In some cases, the usage data is collected in an act 204. Alternatively or additionally, the usage data has already been collected and stored.

The nature of the usage data may vary. Obtaining the usage data may include tracking a time period length or a brightness level of the past operation in an act 206. Separate data may be tracked for different sub-pixel colors. For example, usage hours and brightness levels may be tracked or otherwise obtained for the red, green, and blue sub-pixels of an OLED display panel. Alternative or additional parameters indicative of the past operation may be obtained. For example, the parameters may be or include the accumulated histogram of all of the images shown on the display.

In some cases, obtaining the usage data includes calculating one or more parameters indicative of the past operation of the display. In some cases, one or more brightness-hour parameters are calculated in an act 208. The calculation(s) may be made on data collected in the act 204 or on other data. A wide variety of other parameters may be calculated, including, for instance, an integration of the electroluminescent current that has been passed through the display.

In an act 210, a gamma adjustment profile of a plurality of gamma adjustment profiles is selected based on the obtained usage data. The act 210 may be implemented for each sub-pixel color of the display. For instance, a gamma adjustment profile may be selected for the red, green, and blue sub-pixels of the display panel. In some cases, each sub-pixel color has a respective set of profiles (or other datasets) from which the selection is made. An example of respective sets of profiles is shown in FIG. 1. Alternatively, the selections for the different sub-pixel colors are made from a common set of profiles or datasets.

Selecting the gamma adjustment profile may include determining, in an act 212, an amount of degradation based on the obtained usage data. In some cases, the amount of degradation is determined as a function of the obtained usage data. Alternatively or additionally, the obtained usage data may be correlated with an amount of degradation across a range of usage data values. A lookup table may thus be used to estimate or determine the amount of degradation. The usage data may thus be used in various ways to estimate or otherwise determine an amount of display degradation.

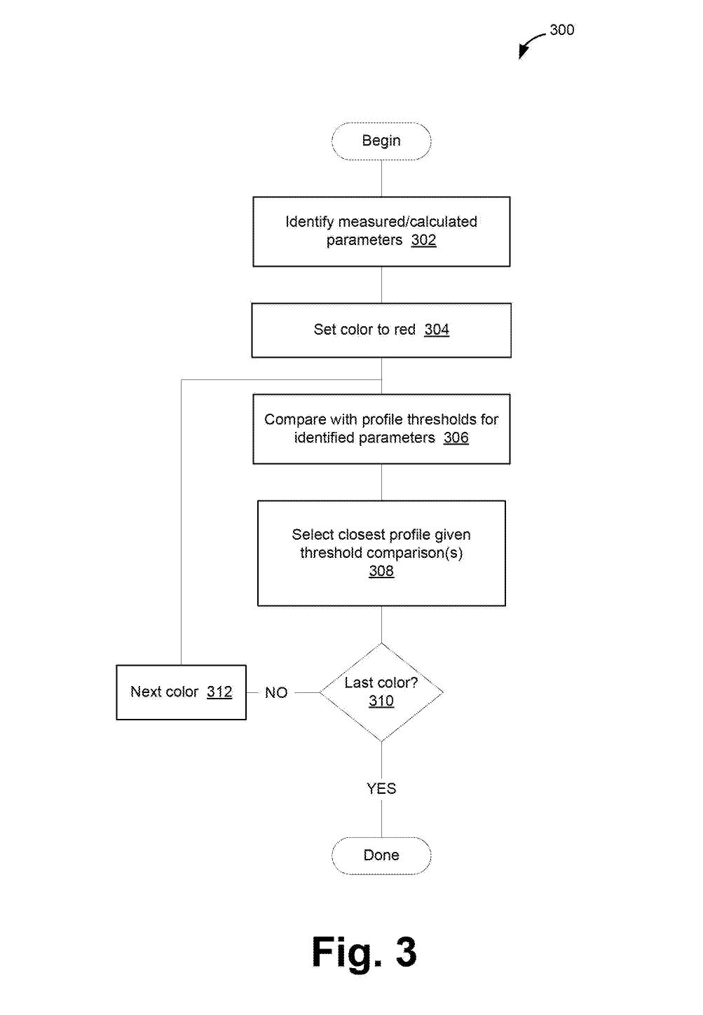

The degradation amount determination may be integrated with the profile selection. In some cases, the profile selection includes implementing a threshold procedure in an act 214 in which the usage data is compared with thresholds associated with degradation amounts (e.g., 5%, 10%, etc.). An example of a threshold-based profile selection procedure is described and shown in connection with FIG. 3.

Selecting the gamma adjustment profile may include access one or more memory units in an act 216. In some cases, each profile is stored on a separate memory unit. For instance, a separate OTP memory may be used to store a respective profile. In other cases, the set of profiles are collectively stored. For example, all of the profiles for a respective sub-pixel color (e.g., red) are stored on a separate memory unit.

In some cases, the profile or dataset used for the gamma adjustment data is simulated or otherwise generated from a profile stored in memory. For instance, a simulated profile may be interpolated or extrapolated from a selected profile in an act 218. The simulated profile may thus be appropriate for usage data that corresponds with a degradation amount that falls between the amounts associated with the stored profiles. For example, if profiles are stored for degradation amounts of 5% and 10%, and if the usage data is indicative of a degradation amount of about 7.5% (or about halfway between 5% and 10%), then a simulated profile may be generated by averaging the two stored profiles. Other interpolations, estimations or calculations may accordingly be implemented for other deviations from the stored profiles.

In an act 220, control signaling for drive circuitry of the display is generated in accordance with the selected gamma adjustment profile (or other dataset). The control signaling may be indicative of one or more gamma-based adjustments. For instance, the control signaling may include one or more gamma voltage signals.

The gamma voltage signal or other control signaling may be generated in accordance with the selected gamma adjustment profile. For instance, the gamma adjustment profile may specify gamma voltages as a function of luminance. The particular gamma voltage signal may be derived from the function. Other derivation techniques may be used, including, for instance, interpolation or extrapolation.

The control signaling may be digital or analog. For instance, the nature of the control signaling may vary in accordance with the extent to which a compensator (or other processor) is integrated with a data driver (or other drive circuitry).

The control signaling may include one or more control signals. For instance, a set of control signals may be generated for a range of luminance values. Respective control signals may be generated for each sub-pixel color.

In some cases, generating the control signaling includes implementing one or more other compensation procedures in addition to the profile-based technique described herein. For instance, an internal compensation procedure may be implemented in an act 222. The internal compensation procedure may use sensor feedback from the pixel array received in an act 224. Implementing the internal compensation procedure may include using the sensor feedback to generate one or more control signals that, for instance, select certain transistors of the TFT backplane for activation.

Alternatively or additionally, the control signaling generation includes implementing an external compensation procedure in an act 226. The external compensation procedure may also be based on the sensor feedback received in the act 224.

The sensor feedback may be optical, electrical and/or other feedback. For instance, the sensor feedback may be indicative of an output of the pixel array. In some cases, the output may be an optical output (e.g., luminance or brightness level). In other cases, the output may be a current level detected in the TFT backplane. The nature of the sensor feedback may vary in accordance with the nature of the additional compensation procedure implemented.

The control signaling generated in the act 220 may assimilate the compensation levels dictated by the compensation techniques. For instance, a gamma voltage signal may be provided to the drive circuitry in an act 228 that adjusts the drive voltage provided to the transistors selected via an internal compensation scheme. Alternatively or additionally, the gamma voltage signal dictated by the profile-based compensation scheme may be adjusted (e.g., upward or downward) in accordance with the sensor feedback processed by an external compensation scheme.

In some cases, the drive circuit control signals are determined in accordance with one or more functions. The function(s) may relate a drive voltage (e.g., Vdata) with one or more other drive circuit parameters, such as power source voltages (e.g., ELVSS, ELVDD) and an OLED drive current.

In an act 230, the drive circuitry generates drive voltage signals for the array of pixels in response to the generated control signaling. The drive circuitry may be responsive to one or more control signals. For instance, one or more control signals may be indicative of gamma voltage levels. Additional control signals may be directed to activating and/or deactivating transistor circuitry in the TFT backplane.

The manner in which the drive circuitry generates the drive voltage signals may vary considerably. For instance, the drive circuitry may vary in accordance with the configuration of the TFT backplane, such as the architecture of each pixel and sub-pixel.

FIG. 3 depicts a procedure 300 for selection of a gamma adjustment profile in accordance with one example. The procedure may be implemented in connection with the act 210 of FIG. 2 or another act. Alternative or additional procedures for selecting a gamma adjustment profile may be implemented. For instance, the procedure of FIG. 3 may be implemented when usage data is obtained for a limited number of usage data parameters. Other procedures may be used when assimilating data for a larger number of usage data parameters.

The procedure 300 uses a number of threshold comparisons to select or determine a gamma adjustment profile. In so doing, the threshold comparisons also estimate or determine an amount of display degradation, insofar as the gamma adjustment profile is correlated with, or otherwise derived from, the amount of display degradation.

The procedure 300 may begin with an act 302 in which one or more parameters are identified or selected for processing. The parameters are indicative of past operation of the display. The parameters may correspond with measured and/or calculated usage data. The nature of the parameters may vary as described above.

In the example of FIG. 3, a respective profile is selected for each sub-pixel color. In this case, the first sub-pixel color to be processed is set in an act 304 to be red. The remaining processing steps are iterated for the other sub-pixel colors.

Other iterative loops may be implemented in other cases. For instance, an iterative loop may be included in the procedure 300 for processing each display zone separately.

The procedure 300 includes an act 306 in which the identified parameters are compared with thresholds. In an example in which usage hours is one of the parameters, the number of usage hours for the past operation of the display is compared with one or more thresholds, such as 1000 hours, 2000 hours, 3000 hours, . . . 10,000 hours. Each threshold is associated with an amount of degradation. In this example, 1000 hours corresponds with 5% degradation, 2000 hours with 10%, 3000 hours with 15%and so on. Additional threshold comparisons may be implemented in accordance with the number of identified parameters.

In an act 308, the gamma adjustment profile with the closest exceeded threshold is selected. If the number of usage hours is greater than 2000 hours, but less than 3000 hours, then the amount of degradation is estimated as 10% (2000 hours). Then the profile associated with 10% degradation is selected.

In cases in which multiple parameters are compared, the act 308 may implement a process to determine a median, average, or other amount of degradation appropriate given the multiple comparisons. For example, if a first parameter leads to a degradation amount of 10%, a second parameter leads to a degradation amount of 20%, and a third parameter leads to a degradation amount of 30%, then the closest profile given all three comparisons is set to 20%. Other calculations may be used to select the closest profile in these multiple comparison cases.

A decision block 210 determines whether the last sub-pixel color has been processed. If yes, the procedure is complete. If not, then control passes to an act 312 in which the next sub-pixel color is selected. Control then returns to the act 306 for the threshold comparisons involving the usage data and thresholds for the selected color. The procedure is then iterated until all of the colors have been processed.

The procedure of FIG. 3 may include fewer, alternative, or additional acts. For instance, the procedure may include acts that modify a selected profile given an offset from the closest, non-exceeded threshold. For example, a pro rata adjustment may be implemented to the data in the selected profile.

With reference again to FIG. 1, the electronic device 100 may be configured as one of a wide variety of computing devices, including, but not limited to, handheld or wearable computing devices (e.g., tablets and watches), communication devices (e.g., phones), laptop or other mobile computers, personal computers (PCs), server computers, set top boxes, programmable consumer electronics, network PCs, minicomputers, mainframe computers, audio or video media players, and other devices. The device 600 may also be configured as an electronic display device, such as a computer monitor, a television, or other display or visual output device.

The memory (or memories) 110 may be or include a buffer, cache, RAM, removable media, hard drive, magnetic, optical, database, or other now known or later developed memory. The memory (or memories) 110 may be a single storage device or computer-readable storage medium, or a group of multiple devices or computer-readable storage media. In some cases, the memory (or memories) 110 may be or include firmware.

The device 100 has sufficient computational capability and system memory to enable basic computational operations. In this example, the computing environment is supported by the CPU or processor 104, which may include one or more processing unit(s) (e.g., standalone processors or integrated processor cores), which may be individually or collectively referred to herein as a processor. The processor 104 and/or the GPU 108 may include integrated memory and/or be in communication with system memory (or memories) 106. The processor 104 and/or the GPU 108 may be a specialized microprocessor, such as a digital signal processor (DSP), a very long instruction word (VLIW) processor, or other microcontroller, or may be a general purpose central processing unit (CPU) having one or more processing cores. The processor 104, the GPU 108, one or more of the memories 106, and/or any other components of the display module 102 may be packaged or otherwise integrated as a system on a chip (SoC), application-specific integrated circuit (ASIC), or other integrated circuit or system.

The memories 110 may also include a variety of computer readable media for storage of information such as computer-readable or computer-executable instructions, data structures, program modules, or other data. Computer readable media may be any available media and includes both volatile and nonvolatile media, whether provided in removable storage and/or non-removable storage.

Computer readable media may include computer storage media and communication media. Computer storage media may include both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may accessed by the processing units of the electronics module 102.

The degradation compensation techniques described herein may be implemented in computer-executable instructions, such as program modules, being executed by the processor 108. Program modules include routines, programs, objects, components, data structures, etc., that perform particular tasks or implement particular abstract data types. The techniques described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices.

The techniques may be implemented, in part or in whole, as hardware logic circuits or components, which may or may not include a processor. The hardware logic components may be configured as Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and/or other hardware logic circuits.

The technology described herein is operational with numerous other general purpose or special purpose computing system environments or configurations. Examples of well-known computing systems, environments, and/or configurations that may be suitable for use with the technology herein include, but are not limited to, personal computers, hand-held or laptop devices, mobile phones or devices, multiprocessor systems, microprocessor-based systems, set top boxes, programmable consumer electronics, network PCs, minicomputers, mainframe computers, distributed computing environments that include any of the above systems or devices, and the like.

The technology herein may be described in the general context of computer-executable instructions, such as program modules, being executed by a computer. Generally, program modules include routines, programs, objects, components, data structures, and so forth that perform particular tasks or implement particular abstract data types. The technology herein may also be practiced in distributed computing environments where tasks are performed by remote processing devices that are linked through a communications network. In a distributed computing environment, program modules may be located in both local and remote computer storage media including memory storage devices.

In one aspect, a display includes a first memory in which a plurality of gamma adjustment datasets are stored, each gamma adjustment dataset of the plurality of gamma adjustment datasets corresponding with a respective amount of display degradation, a second memory in which selection instructions and compensation instructions are stored, and a processor configured via execution of the selection instructions to select one of the plurality of gamma adjustment datasets based on usage data indicative of past display operation. The processor is further configured via execution of the compensation instructions to generate drive control signaling in accordance with the selected gamma adjustment dataset to compensate for display degradation arising from the past display operation.

In another aspect, a display includes an array of pixels, drive circuitry coupled to the array of pixels and configured to drive the array of pixels, a memory in which a plurality of gamma-luminance profiles are stored, each gamma-luminance profile of the plurality of gamma-luminance profiles modeling a respective amount of degradation of the array of pixels, a selector switch configured to select one of the plurality of gamma-luminance profiles based on usage data indicative of past operation of the array of pixels, and a compensator configured to generate control signaling for the drive circuitry in accordance with the selected gamma-luminance profile of the plurality of gamma-luminance profile. The drive circuitry is responsive to the control signaling to compensate for degradation of the array of pixels arising from the past operation.

In yet another aspect, a method of controlling a display includes obtaining usage data indicative of past operation of an array of pixels of the display, selecting a gamma adjustment profile of a plurality of gamma adjustment profiles based on the obtained usage data, generating control signaling for drive circuitry of the display in accordance with the selected gamma adjustment profile, and generating, via the drive circuitry in response to the generated control signaling, drive voltage signals for the array of pixels.

In connection with any one of the aforementioned aspects, the systems, devices, and/or methods described herein may alternatively or additionally include any combination of one or more of the following aspects or features. The usage data includes data indicative of a time period length of the past display operation. The usage data includes data indicative of brightness levels of the past display operation. The processor is further configured to calculate a usage parameter based on the usage data indicative of the past display operation. The processor is further configured via execution of the selection instructions to select one of the plurality of gamma adjustment datasets in accordance with the usage parameter. The processor is further configured via execution of the selection instructions to determine a gamma adjustment profile from the selected one of the plurality of gamma adjustment datasets. The processor is further configured via execution of the compensation instructions to generate the drive control signaling in accordance with the gamma adjustment profile. Each gamma adjustment dataset of the plurality of gamma adjustment datasets is directed to gamma adjustment for a respective sub-pixel color. The display further includes a plurality of display zones. The processor is configured to iteratively implement the selection instructions and the compensation instructions to compensate for the display degradation separately for each display zone of the plurality of display zones. The first memory includes a plurality of programmable storage units, each programmable storage unit of the plurality of programmable storage units having a respective gamma adjustment dataset of the plurality of gamma adjustment datasets stored therein. The display further includes a data storage unit in which the first and second memories are integrated with one another. Each pixel of the array of pixels includes respective internal compensation circuitry. The compensator is further configured to implement internal compensation such that the control signaling for the drive circuitry comprises control signals for the internal compensation circuitry. The compensator is further configured to implement external compensation via feedback from the array of pixels. The display further includes a plurality of display zones. The selector switch and the compensator are configured to operate for a respective zone of the plurality of display zones separate from other zones of the plurality of display zones. The compensator and the selector switch are integrated with one another. Obtaining the usage data includes tracking a time period length of the past operation. Selecting the gamma adjustment profile includes determining an amount of degradation based on the obtained usage data. Selecting the gamma adjustment profile includes interpolating a simulated gamma adjustment profile from the selected gamma adjustment profile. Generating the control signaling includes receiving feedback from the array of pixels, and implementing external compensation in accordance with the received feedback. The act of selecting the gamma adjustment profile is implemented for each sub-pixel color of the display.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A display comprising:
a first memory in which a plurality of gamma adjustment datasets are stored, each gamma adjustment dataset of the plurality of gamma adjustment datasets corresponding with a respective amount of display degradation;
a second memory in which selection instructions and compensation instructions are stored; and
a processor configured via execution of the selection instructions to select one of the plurality of gamma adjustment datasets based on usage data indicative of past display operation;
wherein the processor is further configured via execution of the compensation instructions to generate drive control signaling in accordance with the selected gamma adjustment dataset to compensate for display degradation arising from the past display operation.

2. The display of claim 1, wherein the usage data comprises data indicative of a time period length of the past display operation.

3. The display of claim 1, wherein the usage data comprises data indicative of brightness levels of the past display operation.

4. The display of claim 1, wherein:
the processor is further configured to calculate a usage parameter based on the usage data indicative of the past display operation; and
the processor is further configured via execution of the selection instructions to select one of the plurality of gamma adjustment datasets in accordance with the usage parameter.

5. The display of claim 1, wherein:
the processor is further configured via execution of the selection instructions to determine a gamma adjustment profile from the selected one of the plurality of gamma adjustment datasets; and
the processor is further configured via execution of the compensation instructions to generate the drive control signaling in accordance with the gamma adjustment profile.

6. The display of claim 1, wherein each gamma adjustment dataset of the plurality of gamma adjustment datasets is directed to gamma adjustment for a respective sub-pixel color.

7. The display of claim 1, further comprising a plurality of display zones, wherein the processor is configured to iteratively implement the selection instructions and the compensation instructions to compensate for the display degradation separately for each display zone of the plurality of display zones.

8. The display of claim 1, wherein the first memory comprises a plurality of programmable storage units, each programmable storage unit of the plurality of programmable storage units having a respective gamma adjustment dataset of the plurality of gamma adjustment datasets stored therein.

9. The display of claim 1, further comprising a data storage unit in which the first and second memories are integrated with one another.

10. A display comprising:
an array of pixels;
drive circuitry coupled to the array of pixels and configured to drive the array of pixels;
a memory in which a plurality of gamma-luminance profiles are stored, each gamma-luminance profile of the plurality of gamma-luminance profiles modeling a respective amount of degradation of the array of pixels;
a selector switch configured to select one of the plurality of gamma-luminance profiles based on usage data indicative of past operation of the array of pixels; and
a compensator configured to generate control signaling for the drive circuitry in accordance with the selected gamma-luminance profile of the plurality of gamma-luminance profile;
wherein the drive circuitry is responsive to the control signaling to compensate for degradation of the array of pixels arising from the past operation.

11. The display of claim 10, wherein:
each pixel of the array of pixels comprises respective internal compensation circuitry;
the compensator is further configured to implement internal compensation such that the control signaling for the drive circuitry comprises control signals for the internal compensation circuitry.

12. The display of claim 10, wherein the compensator is further configured to implement external compensation via feedback from the array of pixels.

13. The display of claim 10, further comprising a plurality of display zones, wherein the selector switch and the compensator are configured to operate for a respective zone of the plurality of display zones separate from other zones of the plurality of display zones.

14. The display of claim 10, wherein the compensator and the selector switch are integrated with one another.

15. A method of controlling a display, the method comprising:
obtaining usage data indicative of past operation of an array of pixels of the display;
selecting a gamma adjustment profile of a plurality of gamma adjustment profiles based on the obtained usage data;
generating control signaling for drive circuitry of the display in accordance with the selected gamma adjustment profile; and
generating, via the drive circuitry in response to the generated control signaling, drive voltage signals for the array of pixels.

16. The method of claim 15, wherein obtaining the usage data comprises tracking a time period length of the past operation.

17. The method of claim 15, wherein selecting the gamma adjustment profile comprises determining an amount of degradation based on the obtained usage data.

18. The method of claim 15, wherein selecting the gamma adjustment profile comprises interpolating a simulated gamma adjustment profile from the selected gamma adjustment profile.

19. The method of claim 15, wherein generating the control signaling comprises:
receiving feedback from the array of pixels; and
implementing external compensation in accordance with the received feedback.

20. The method of claim 15, wherein the act of selecting the gamma adjustment profile is implemented for each sub-pixel color of the display.
